(19) United States
(12) Patent Application Publication
(10) Pub. No.: US 2012/0215571 A1
(43) Pub. Date: Aug. 23, 2012

(54) System and Method for Online Self-Badging

(76) Inventor: Susan Bracken, Alexandria, VA (US)

(21) Appl. No.: 13/401,982

(22) Filed: Feb. 22, 2012

Related U.S. Application Data
(60) Provisional application No. 61/457,308, filed on Feb. 22, 2011.

(51) Int. Cl. G06Q 10/02; G06K 15/02

(52) U.S. Cl. 705/5; 358/1.18

(57) ABSTRACT

A computer-implemented method for self-registration by an attendee for an event, wherein the attendee accesses via the internet a log-in screen for the event organizer and inputs personal information required for that event. The event organizer provides to the attendee via the internet registration and payment information, and the attendee registers and pays fees for the event. Following confirmation of receipt of payment and registration, the attendee generates a badge electronically. The event organizer generates a document containing the badge; the attendee prints the document, cuts the badge from it and takes the pre-printed badge to the event. The event organizer verifies the badge and mates it with an event-specific badge holder that coordinates with the badge to serve as a credential valid for use at the event.

This application claims the benefit of U.S. Provisional Patent Application No. 61/457,308, filed Feb. 22, 2011.

### FIELD OF THE INVENTION

This invention relates a system and method for online registration and badging by attendees to gain access to an event such as a convention, conference, seminar, symposium, tradeshow, exhibition, meeting, and the like. In particular, in accordance with the invention a potential attendee at an event registers online and produces and prints his or her own badge and tickets (if applicable). The attendee presents the pre-printed badge for validation at the site of the event and if applicable the badge is matched with a badge holder specific to the event and to the category of attendance for which that attendee has registered.

### BACKGROUND THE INVENTION

Professional meetings and events typically are organized and managed by event organizers. In accordance with current industry practice, the event organizer sends registration packets via US mail to attendees, participants, sponsors, exhibitors, speakers, guests, and news media. Preparation and mailing of these packets requires many hours of labor and costs many thousands of dollars. Additional time and expense is required to process applications returned to the event organizer. After the completed meeting registration application has been processed and prepaid registration and conference fees paid by the attendees have been cleared and settled, the participants and attendees receive notification that they may attend the scheduled meeting and any other associated special event. It is common practice for the event organizer to prepare event badges based on the data that has been provided by the attendee and to distribute these badges to the attendees at the site of the event.

More specifically, traditional methods for badging attendees at meetings, conferences, expositions, and the like, involve the mass production of badges and corresponding tickets by registration contractors or event organizers equipped with their own badge making technology and equipment. These badges/tickets are produced and manually collated and stuffed into envelopes to be mailed to attendees/exhibitors prior to the meeting.

The traditional method also requires that deadlines be published for attendees who wish to receive their badge/tickets in advance of the event. A typical cut-off date for a badge mailing would be 3-4 weeks before the event is scheduled to take place.

Another traditional method requires attendees/exhibitors to pick up all their badges/tickets onsite either just before the event opens or at some point before the event closes, requiring the event organizer to provide numerous badge printing stations (computers and printers) onsite to facilitate the production process. Alternatively, the event organizer pre-prints all badges/tickets and manually stuffs them in envelopes that are arranged in alphabetical order for pick-up onsite by attendees/exhibitors. Printing and/or picking up badges and tickets at the site of the event is inefficient and can lead to long lines and delays in processing attendees.

As can be seen, current systems and methods for registering and badging attendees at conventions, trade shows, and the like, are highly inefficient, very labor intensive and costly for meet organizers. Moreover, current systems and methods make it difficult to collect and manage data about the attendees.

### DISCLOSURE OF THE INVENTION

In accordance with the invention, a potential attendee at an event registers online or by mail, fax or telephone. At the conclusion of the registration process, including processing of applicable registration and conference fees, the event organizer sends a receipt/confirmation to the attendee. Badges and tickets are generated electronically after payment is received. The event organizer may choose to have the confirmation contain a link that allows the attendee to access their event badge online and print it at this time. Another option is to not include a link on the receipt/confirmation and rather email the attendee/exhibitor at a pre-determined time, typically 2-3 weeks prior to the event, alerting them that their badge and any accompanying tickets are ready for printing. The email does three things: (1) provides a “proof' of the badge; (2) allows the attendee to access their record and change/edit the information appearing on the badge; and (3) print his or her own badge and tickets (if applicable) at any date/time, from any location using the printer of their choice. When the attendee chooses “print my badge” the system generates a document unique to that individual. This document contains the badge and any corresponding event tickets. The document includes instructions to cut the badge from the document and report to the designated badge holder pick-up area at the event venue to obtain the official badge holder. Other instructions, sponsor messages and advertising may also appear on this document.

When the attendee/exhibitor chooses “edit my badge” they are automatically directed to their registration record where they may edit the fields of data that display on the badge. When done editing their record they may choose to exit the system without printing or they may print their badge.

Each badge/ticket contains a barcode that is unique to the registrant. The barcode is used to verify attendance at onsite badge holder distribution stations and to control access to ticketed events.

Upon arrival at the meeting, exhibitors/attendees report to badge holder pick-up stations/counters located in various areas of the host facility. Attendees/exhibitors surrender their badge to attendants who scan the barcode (unique to each registrant) to authenticate and validate the badge. At this time the status of the individual's registration record is changed to “check-in”. This process eliminates the ability for registrants to unlawfully reproduce badges. The system is also programmed to verify that the registrant's record is in good standing. This means there is no balance/payments due and that the record has not be cancelled or transferred to another attendee/exhibitor. If this was the case the registrant would be unable to obtain a valid badge holder. After the validation process is complete the attendee/exhibitor is given an event specific badge holder designed specifically to work with the system and method of the invention.

The badge holders are specially designed and act as the control mechanism by being unique to each event. Meetings that require the same badge holder for all participants would utilize a basic 3″×4″ badge holder, although badge size is not restricted when using the self-badging method of the invention, that is pre-screened/printed with logos, event name and/or other information that distinguishes the holder as unique to that specific meeting. When the holder is mated with the paper badge the credential is then valid for use at the meeting. The badge can be used for identification purposes and/or to validate entry in and out of events, social functions, etc.

Meetings that require special designation as to the type of registrant i.e., attendees, exhibitors, speakers, press, VIP's, staff, vendors, security, etc. or events that designate people by their professional status i.e., buyer, seller, distributor, physician, nurse, technician or any other professional designation, would utilize a series of unique badge holders that are color coded based on category.

Color coded badge holders can also be used in conjunction with the self-produced paper badge to control/limit access to certain sessions, meetings, social events or specific areas in the meeting facility. They can also be used to identify one-day registrants or exposition only registrants from those that purchased access to the entire meeting, etc. Holders are distributed onsite after identification is validated, eliminating concerns about unlawful reproduction of credentials.

The system tracks the number of times a registrant prints their badge prior to the meeting, updates their registrant record status to “checked-in” upon scanning of the barcode at badge holder pick-up stations, and triggers reminder emails to those who have not printed their badges in advance. These email notifications are customizable and may be sent in unlimited quantities as deemed necessary by the event organizer.

After the event is concluded, reports are available to event organizers that indicate how many badges were scanned at badge holder pick-up areas. This data can be provided in a variety of formats, i.e., by date/time, by station, etc. Reports are also available that indicate how many badges were printed by attendees/exhibitors prior to arriving at the host venue, how many attendees/exhibitors did not print their badge and how many attendees attempted to forge their badge.

Event organizers using the self-badging method of the invention will have better data about who has and has not printed their materials, allowing them to modify/adjust their onsite equipment and personnel needs. This will result in lower operating costs and improve the check-in process for their attendees/exhibitors. Currently there is no measurement available to ascertain how many attendees/exhibitors received their badges/tickets in the mail.

Data collected through the system and method of the invention allows for better pre-planning There is reduced environmental impact due to the reduction in the amount of paper products used in comparison with traditional methods which include pre-printing of badges/tickets so they could be mailed or placed in envelopes for onsite pick-up by attendees/exhibitors. In many cases event organizers use the badge mailing as a vehicle to deliver other printed advertising and/or informational literature. The self-badging process of the invention would facilitate electronic delivery of these traditionally paper documents.

The system and method of the invention greatly improves operational efficiencies and saves money: there is no need to produce and mail badges; there are no postage expenses; less onsite equipment and staffing is needed; there are reduced shipping costs; there are no badge/ticket design and printing expenses; and there is no pre-registration cut-off date. A typical cut-off date for a badge mailing would be 3-4 weeks before the event is scheduled to stage. Self-badging in accordance with the invention is available 24/7 and requires no pre-show deadline for advance registration. Attendees simply register online and print their own badge and tickets (if applicable). Badges and tickets are generated electronically after payment is received. Each badge/ticket contains a barcode that is unique to the registrant. The barcode is used to verify attendance at onsite badge holder distribution stations and control access to ticketed events. Much like e-tickets for sporting events, shows, the theatre and airlines, this self-badging system drastically reduces expenses and increases efficiencies.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a schematic diagram of the system organization of the invention.

FIG. 2 is a flow chart depicting the system process of the invention.

FIG. 3 depicts the Log-In Screen through which the registrant/attendee logs in to the event organizer's registration site.

FIG. 4 depicts the Profile Information Screen through which the registrant/attendee fills out and uploads to the event organizer all personal information required by client for the particular event under consideration.

FIG. 5 depicts the Demographics page through which the registrant/attendee provides demographic information required by the client for the particular event.

FIG. 6 depicts the Registration Options Page through which the registrant/attendee chooses the type of registration for the particular conference (based on member type/conference type/ any other designations by client).

FIG. 7 depicts the Payment Due/Badge Preview page through which the registrant/attendee reviews registration type and payment information. This page also allows the registrant to preview the badge for the first time.

FIG. 8 depicts the Payment Screen through which the registrant/attendee supplies payment for the registration type, choosing options provided by the client.

FIG. 9 depicts the Confirmation/Badge Print Page sent to the email address provided by the registrant/attendee and through which the registrant/attendee receives confirmation of his or her registration and payment, and which also allows the registrant/attendee the option to print his or her badge if ready.

FIG. 10 depicts the Print Badge Option Page through which the registrant/attendee can open and print his or her badge or save the file to their computer for later printing.

FIG. 11 depicts the email Badge/Information Page from which the registrant/attendee, at his or her convenience, prints the official meeting badge and information page and cuts out the badge.

FIG. 12 is a screen image of a completed information sheet with a completed badge ready to be cut out and presented at the site of the event for validation and insertion into a badge holder unique to that event.

FIG. 13 is a picture of a badge after it is cut from the information sheet.

FIG. 14 is a picture of a badge holder for mating with the badge of FIG. 13.

FIG. 15 is a picture of a badge inserted into a holder to produce an event credential according to the invention.

### DETAILED DESCRIPTION OF THE PREFERRED EMBODIMENTS

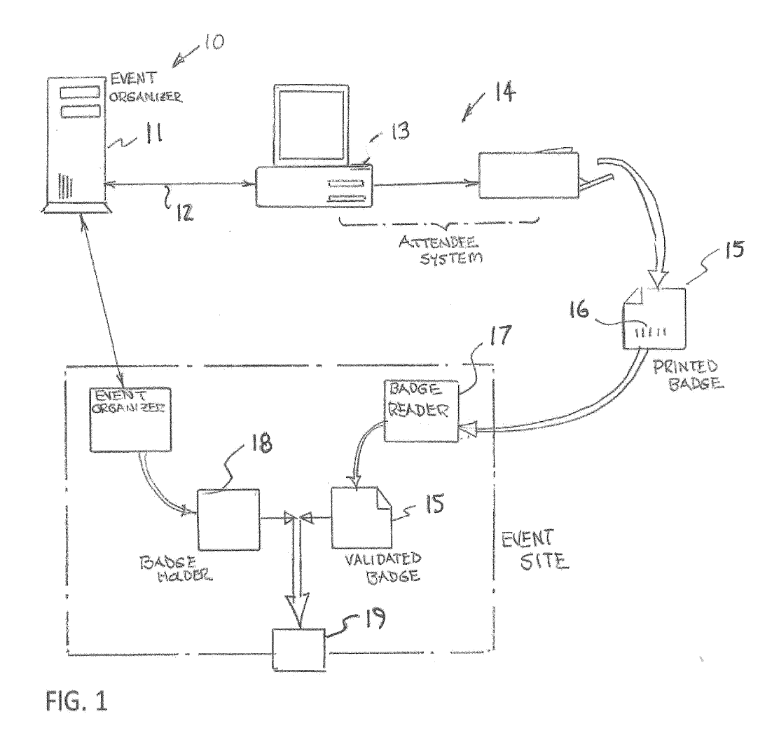

With more specific reference to the drawings, a system for practicing the invention is shown in FIG. 1. The event organizer 10 prepares a registration format and stores it on its server 11 for access via the internet 12 and computer 13 by a potential registrant/attendee 14. At the conclusion of the registration process, including processing of applicable registration and conference fees, the event organizer sends a receipt/confirmation to the attendee. Badges and tickets are generated electronically after payment is received. The event organizer may choose to have the confirmation contain a link that allows the attendee to access their event badge online and print it at this time. Another option is to not include a link on the receipt/confirmation and rather email the attendee/exhibitor at a pre-determined time, typically 2-3 weeks prior to the event, alerting them that their badge and any accompanying tickets are ready for printing.

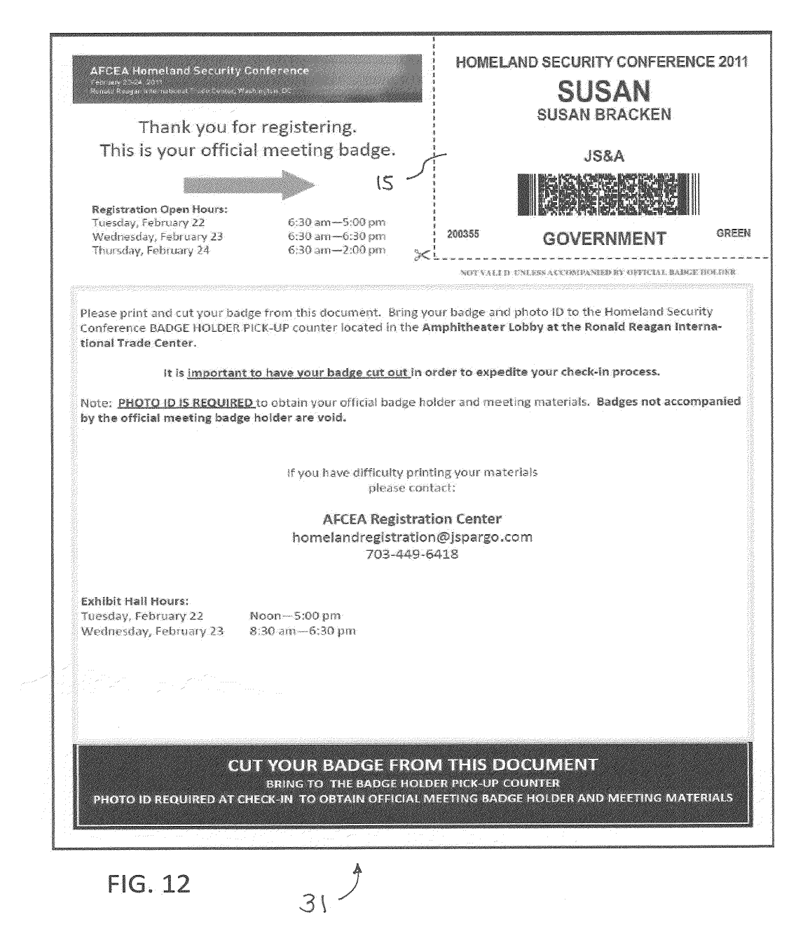

The attendee/exhibitor prints his or her badge 15, which contains a barcode 16 (see FIGS. 11 and 12) and takes it to a Badge Holder Pick-up Area at the site of the event, where the registrant/attendee presents a photo ID and the badge is scanned by a badge reader 17 to authenticate and validate the badge. The badge is then inserted in a badge holder 18 provided by the event organizer to produce a finished credential 19. The badge holder is unique to that event and to a particular category of attendee/exhibitor. In a preferred embodiment the badge holder is color coded, for example.

The badge holders 18 are specially designed and act as the control mechanism by being unique to each event. Meetings that require the same badge holder for all participants would utilize a basic 3″×4″ badge holder, although badge size is not restricted when using the self-badging method of the invention, that is pre-screened/printed with logos, event name and/or other information that distinguishes the holder as unique to that specific meeting. When the holder is mated with the paper badge the credential is then valid for use at the meeting. The badge can be used for identification purposes and/or to validate entry in and out of events, social functions, etc.

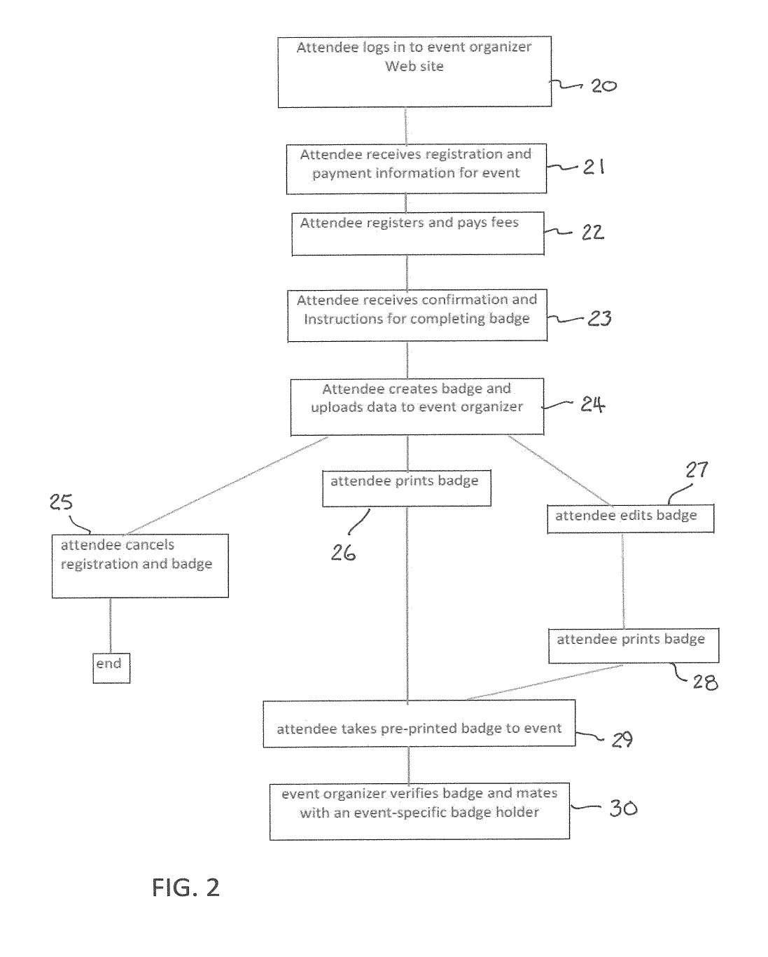

The flow chart shown in FIG. 2 illustrates the steps followed in practicing the method of the invention. Thus, the attendee logs in to the event organizer web site at 20 and receives registration and payment information for the event at 21. The attendee can then register and pay fees at 22, after which they receive confirmation and instructions for completing their badge at 23. The attendee creates his or her badge and uploads data to the event organizer at 24. The attendee can cancel his or her registration and badge by selecting option 25, or can print his or her badge at this time at 26, or can choose to edit their badge at 27 and then print it at 28. The attendee then takes his or her badge to the site of the event at 29, where it is validated and mated with an event-specific badge holder at 30.

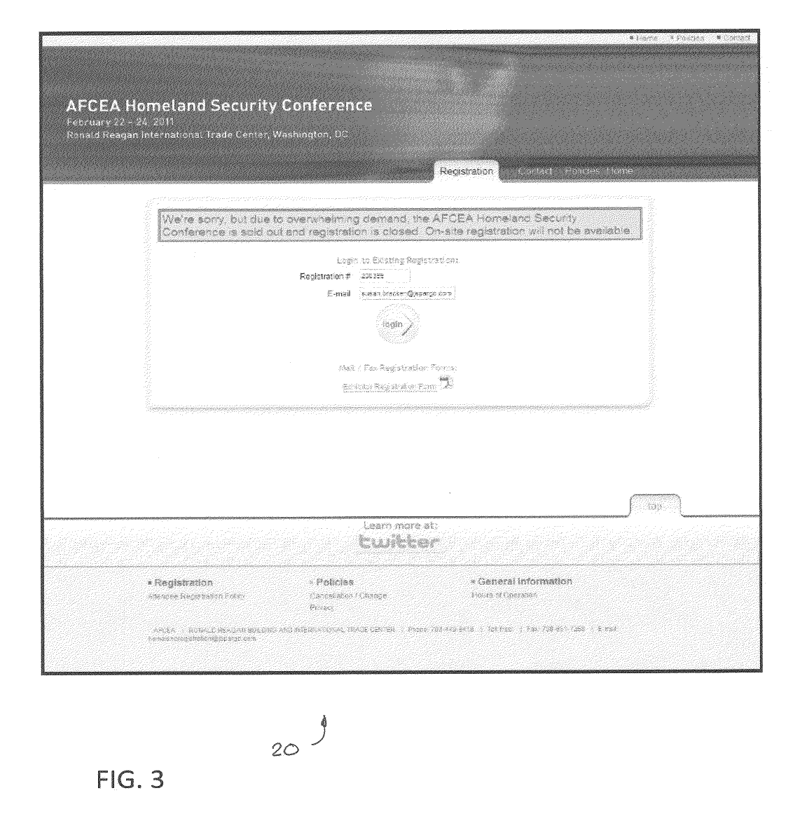

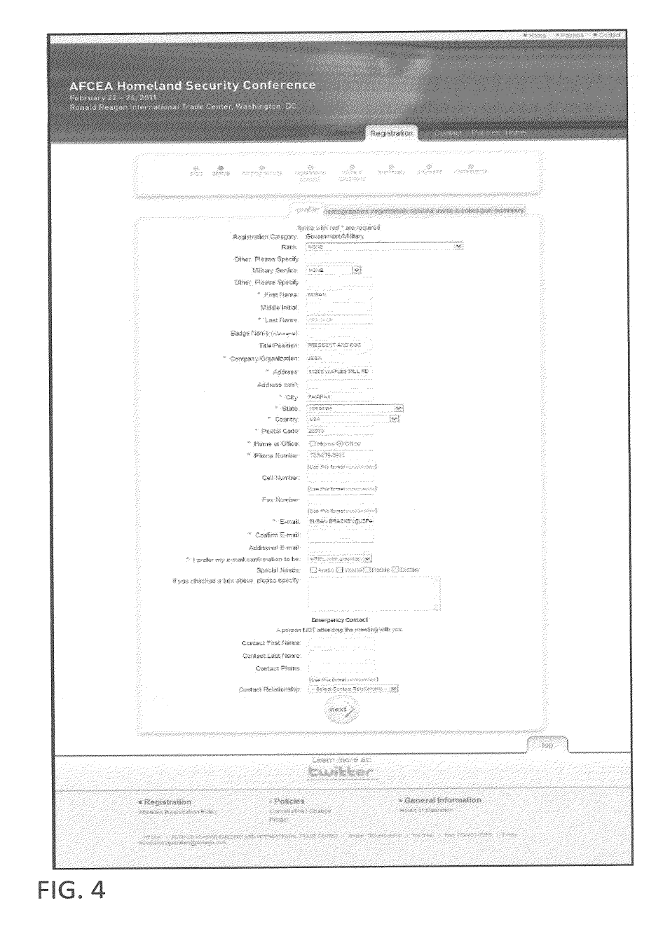

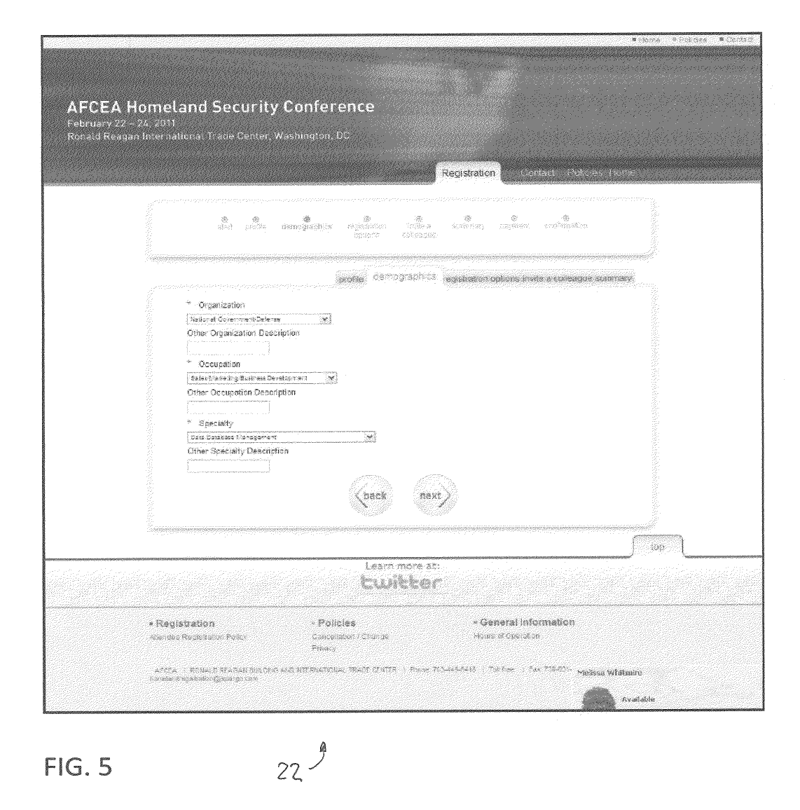

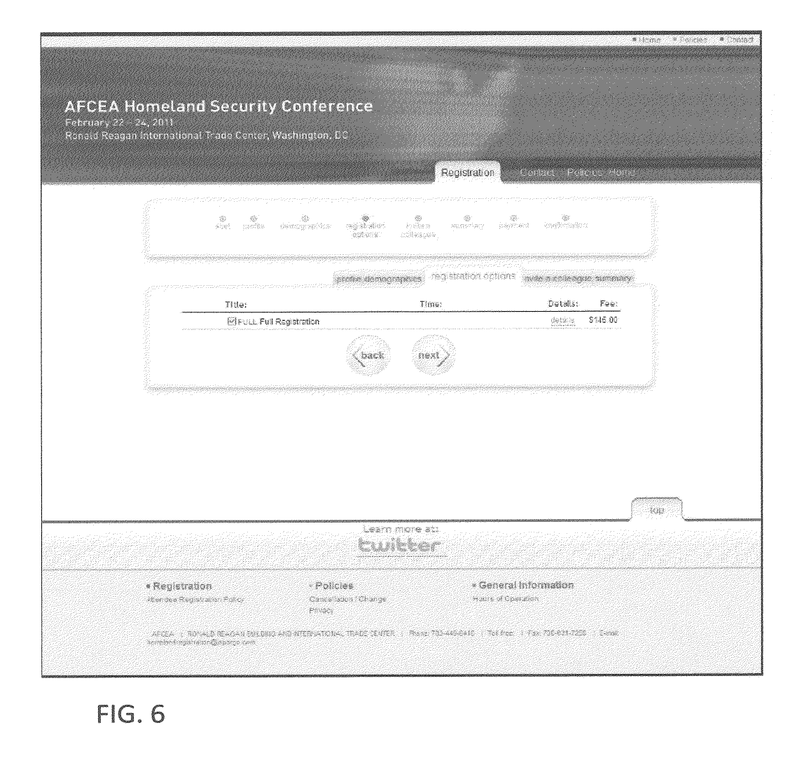

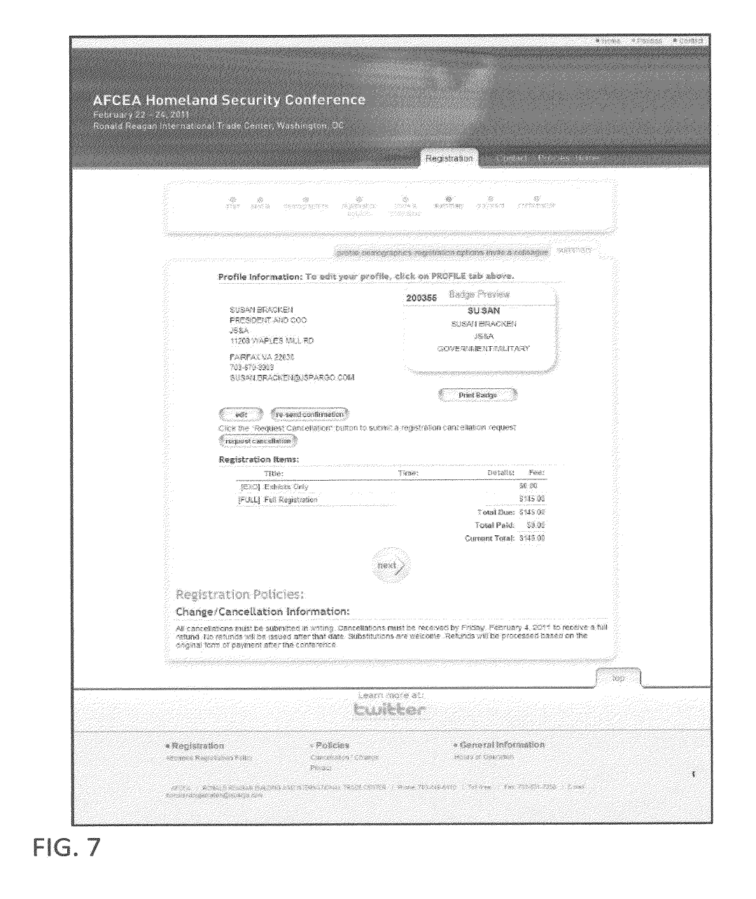

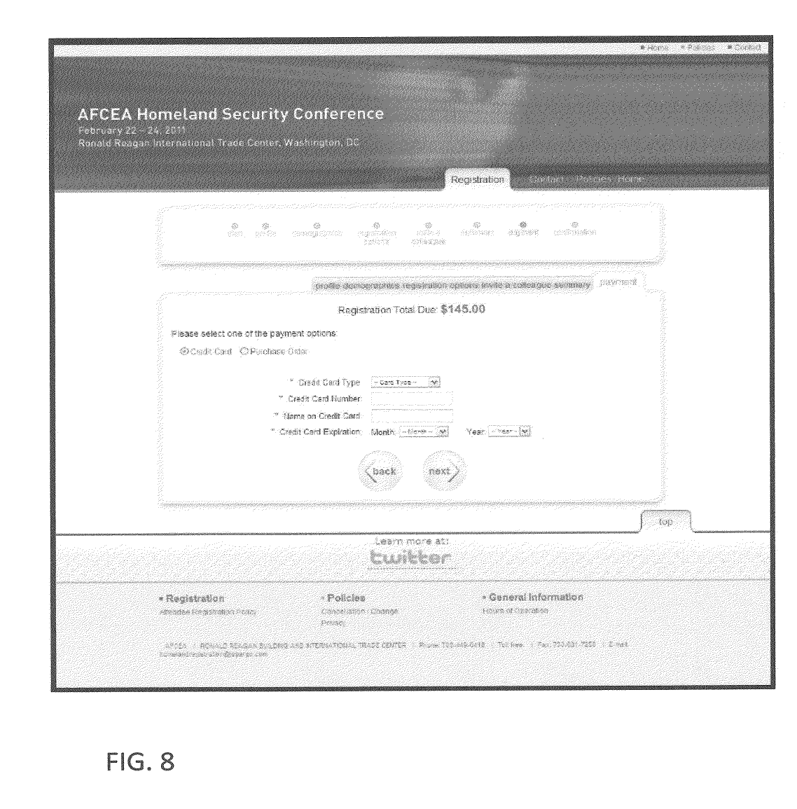

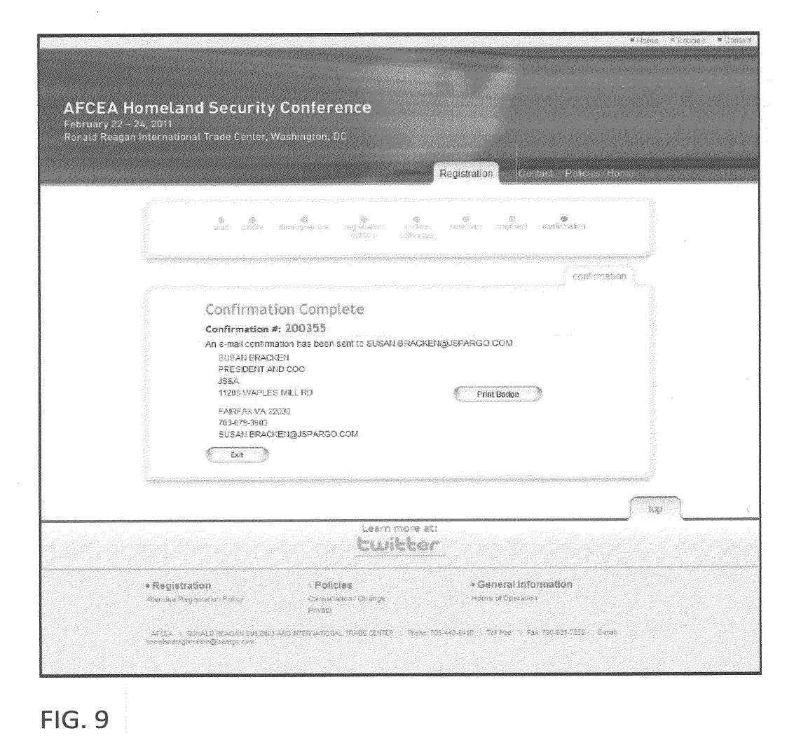

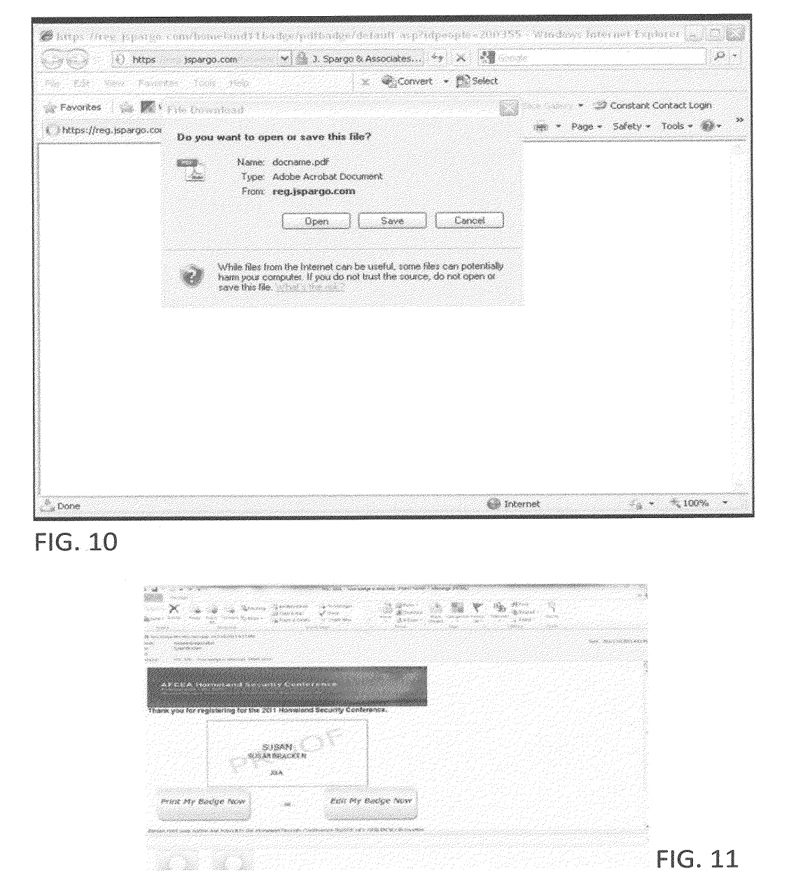

FIGS. 3-12 are screen shots of images provided by the event organizer and that appear on the registrant/attendees system. FIG. 3 shows the log-in screen; FIGS. 4-7 are various screens for inputting data; FIG. 8 shows the registration fee due and provides different methods for payment; FIG. 9 is the confirmation screen that registration and payment has been completed; FIG. 10 gives the attendee the option of saving or opening the file so that the document containing the badge can be printed; FIG. 11 is the email notification that enables the attendee to edit or print the badge (by clicking on “print” the attendee would be taken to screen 10). By selecting the various options provided on the screens, the registrant/attendee enters data required by the client for that event. Badges and tickets are generated electronically after payment is received. When the registrant/attendee has completed the registration process, the event organizer may choose to have the confirmation contain a link that allows the attendee to access their event badge online and print it at this time. Another option is to not include a link on the receipt/confirmation and rather email the attendee/exhibitor at a pre-determined time, typically 2-3 weeks prior to the event, alerting them that their badge and any accompanying tickets are ready for printing. The email does three things: (1) provides a “proof' of the badge; (2) allows the attendee to access their record and change/edit the information appearing on the badge; and (3) print his or her own badge and tickets (if applicable) at any date/time, from any location using the printer of their choice.

When the attendee/exhibitor chooses “edit my badge” they are automatically directed to their registration record where they may edit the fields of data that display on the badge. When done editing their record they may choose to exit the system without printing or they may print their badge.

When the attendee chooses “print my badge” the system generates a document 31 unique to that individual. See FIG. 12. This document contains the badge and any corresponding event tickets. The document includes instructions to cut the badge from the document and report to the designated badge holder pick-up area at the event venue to obtain the official badge holder. Other instructions, sponsor messages and advertising may also appear on this document.

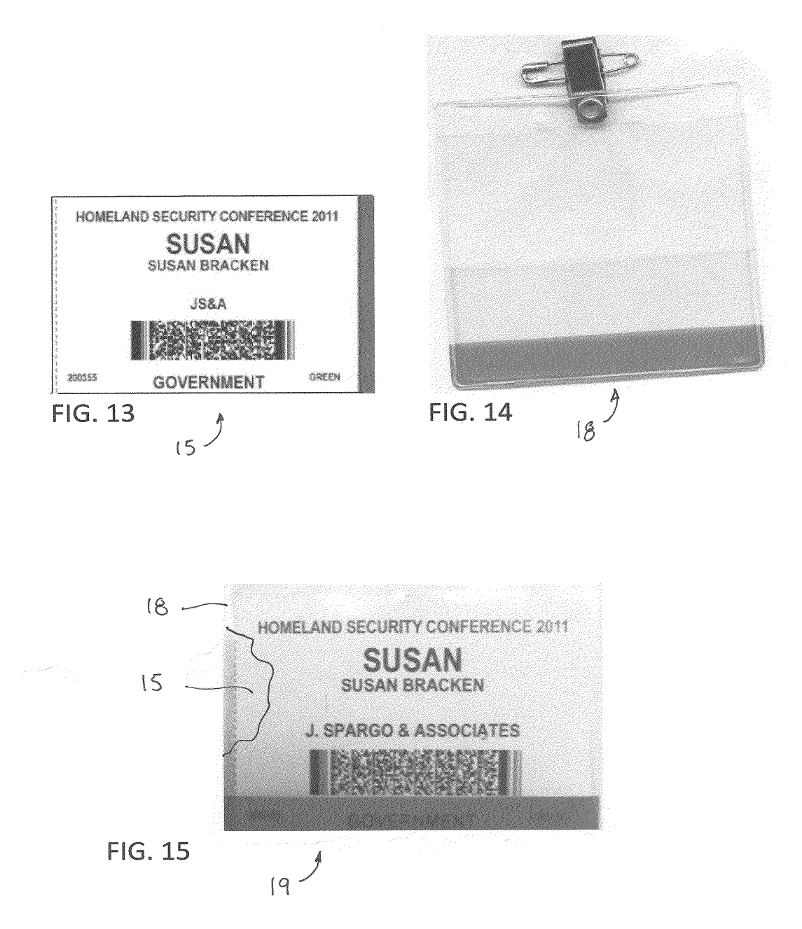

FIG. 13 depicts a badge that has been cut from the document 31, and FIG. 14 depicts a color coded badge holder into which the badge is inserted to produce the finished credential as shown at 19 in FIG. 15.

The system and method of the invention greatly improves operational efficiencies and saves money: there is no need to produce and mail badges; there are no postage expenses; less onsite equipment and staffing is needed; there are reduced shipping costs; there are no badge/ticket design and printing expenses; and there is no pre-registration cut-off date. A typical cut-off date for a badge mailing would be 3-4 weeks before the event is scheduled to stage. Self-badging in accordance with the invention is available 24/7 and requires no pre-show deadline for advance registration. Attendees simply register online and print their own badge and tickets (if applicable). Badges and tickets are generated electronically after payment is received. Each badge/ticket contains a barcode that is unique to the registrant. The barcode is used to verify attendance at onsite badge holder distribution stations and control access to ticketed events.

While particular embodiments of the invention have been illustrated and described in detail herein, it should be understood that various changes and modifications may be made in the invention without departing from the spirit and intent of the invention as defined by the appended claims.

What is claimed is:

1. A computer-implemented method for self-registration by an attendee for an event, wherein:
the attendee uses a computer terminal to access via the internet a log-in screen for the event organizer and inputs personal and demographic information required for that event;
the event organizer provides to the attendee via the internet registration and payment information for the event based on information provided by the attendee;
the attendee registers and pays fees for the event via the internet;
the event organizer provides to the attendee via the internet confirmation of receipt of registration and payment and provides instructions for creating a badge for attending the event;
the attendee generates a badge electronically and uploads data to the event organizer;
the event organizer generates a document unique to that attendee based on the information provided by the attendee, said document containing the badge, any corresponding event tickets, and instructions to cut the badge from the document and report to a designated badge holder pick-up area at the event venue to obtain an official badge holder;
the attendee prints the document, cuts the badge from it and takes the pre-printed badge to the event; and
the event organizer verifies the badge and mates it with an event-specific badge holder.

2. A computer-implemented method as claimed in claim 1, wherein:
the event organizer optionally provides a link in the confirmation of receipt of registration and payment that allows the attendee to access their event badge online and print it at this time or does not provide a link in the confirmation of receipt of registration and payment but rather emails to the attendee at a pre-determined time in the future, alerting them that their badge and any accompanying tickets are ready for printing.

3. A computer-implemented method as claimed in claim 1, wherein:
after generating a badge electronically and uploading data to the event organizer but before printing the badge, the attendee edits the badge.

4. A method for enabling a potential attendee at an event to pre-register and pre-print a badge unique to that event, wherein:
an event organizer prepares a registration format and stores it on its server for access via the internet and a remote computer terminal by a potential attendee;
a potential attendee uses a remote computer terminal to upload to the event organizer personal and demographic information required for that event;
the event organizer provides to the potential attendee via the internet registration and payment information for the event based on information provided by the attendee;
the potential attendee registers and pays fees for the event via the internet;
at the conclusion of the registration process, including processing of applicable registration and conference fees, the event organizer sends a receipt and confirmation to the attendee and electronically generates badges and any applicable tickets;
the event organizer includes a link in the receipt and confirmation that allows the potential attendee to access their event badge online and print it at this time;
the potential attendee prints his or her badge, which contains a barcode unique to that event and that attendee;
the attendee takes the pre-printed badge to the site of the event, where the attendee presents a photo ID and the badge is scanned by a badge reader to authenticate and validate the badge; and
the badge is then inserted in a badge holder provided by the event organizer to produce a finished credential, wherein the badge holder is unique to that event and to a particular category of attendee.

5. A method for enabling a potential attendee at an event to pre-register and pre-print a badge unique to that event, wherein:
an event organizer prepares a registration format and stores it on its server for access via the internet and a remote computer terminal by a potential attendee;
a potential attendee uses a remote computer terminal to upload to the event organizer personal and demographic information required for that event;
the event organizer provides to the potential attendee via the internet registration and payment information for the event based on information provided by the attendee;
the potential attendee registers and pays fees for the event via the internet;
at a pre-determined future time following conclusion of the registration process, including processing of applicable registration and conference fees, the event organizer sends an email to the potential attendee, alerting them that their badge and any accompanying tickets are ready for printing;
the potential attendee edits his or her badge if desired or necessary and prints the badge, which contains a barcode unique to that event and that attendee;
the attendee takes the pre-printed badge to the site of the event, where the attendee presents a photo ID and the badge is scanned by a badge reader to authenticate and validate the badge; and
the badge is then inserted in a badge holder provided by the event organizer to produce a finished credential, wherein the badge holder is unique to that event and to a particular category of attendee.

6. A method for enabling a potential attendee at an event to pre-register and pre-print a badge unique to that event, wherein:
the badge holder is pre-screened or printed with logos, event name and/or other information that distinguishes the holder as unique to that specific meeting and when mated with the paper badge inserted in it forms a credential valid for use at the event.
